(19) United States
(12) Patent Application Publication
(10) Pub. No.: US 2024/0357578 A1
(43) Pub. Date: Oct. 24, 2024

(54) OPTIMIZE POWER CONSUMPTION BY REDUCING THE TRANSMISSION NUMBER OF SR/PUSCH

(71) Applicant: MEDIATEK Inc., Hsinchu City (TW)

(72) Inventors: Tse-Wei LIN, Hsinchu City (TW); Shih-Ping LIANG, Hsinchu City (TW); Jia-Shi LIN, Hsinchu City (TW)

(21) Appl. No.: 18/640,253

(22) Filed: Apr. 19, 2024

Related U.S. Application Data
(60) Provisional application No. 63/496,980, filed on Apr. 19, 2023.

(51) Int. Cl. H04W 72/12; H04L 43/0829; H04W 76/28

(52) U.S. Cl. CPC H04W 72/12; H04L 43/0829; H04W 76/28

(57) ABSTRACT

A technology to optimize power consumption by reducing the transmission number of SR/PUSCH is provided. The controlling method for the user equipment includes the following steps: determining whether the user equipment receives a scheduling request (SR) configuration from a network; reducing SR transmission number by selecting a plurality of SR occasions; and transmitting a SR signal according to selected SR occasions.

This application claims the benefit of U.S. Provisional application Ser. No. 63/496,980, filed Apr. 19, 2023, the disclosure of which is incorporated by reference herein in its entirety.

### TECHNICAL FIELD

The disclosure relates in general to optimize power consumption by reducing the transmission number of SR/PUSCH.

### BACKGROUND

Along with the development of the communication technology, varied communication devices are invented. If the communication device performs data transmission, such as VoLTE, VoNR or streaming, the communication device would transmit a scheduling request (SR) signal to the network and receives an uplink grant signal. After receiving the uplink grant signal, the communication device could transmit the data packet to the network. However, frequent transmission will result in rapid power consumption. How to reduce power consumption has become the most important research and development direction of the communication technology.

### SUMMARY

The disclosure is directed to optimize power consumption by reducing the transmission number of SR/PUSCH. The transmission number of the scheduling request (SR) and the PUSCH transmission is reduced for power saving. The SR transmission number of the scheduling request (SR) could be dynamically adjusted.

According to one embodiment, a controlling method for a user equipment which is a communication device is provided. The controlling method for the user equipment includes the following steps: determining whether the user equipment receives a scheduling request (SR) configuration from a network; reducing SR transmission number by selecting a plurality of SR occasions; and transmitting a SR signal according to selected SR occasions.

According to another embodiment, a modem chip equipped in a user equipment which is a communication device is provided. The modem chip is used to: determine whether the user equipment receives a scheduling request (SR) configuration from a network; reduce SR transmission number by selecting a plurality of SR occasions; and control the wireless communication module to transmit a SR signal according to selected SR occasions.

According to an alternative embodiment, a user equipment which is a communication device is provided. The user equipment includes a wireless communication module and a modem chip. The modem chip is connected to the wireless communication module. The modem chip is used to: determine whether the user equipment receives a scheduling request (SR) configuration from a network; reduce SR transmission number by selecting a plurality of SR occasions; and control the wireless communication module to transmit a SR signal according to selected SR occasions.

### BRIEF DESCRIPTION OF THE DRAWINGS

FIG. 1 illustrates the data pattern according to one embodiment of the present disclosure.

FIG. 2 shows the transmission between the network and the user equipment in the examples of VoLTE and/or VoNR according to one embodiment of the present disclosure.

FIG. 3 illustrates the data transmission for the data packet according to one embodiment of the present disclosure.

FIG. 4 illustrates the discontinuous reception (DRX) active time overlap for the user equipment according to one embodiment of the present disclosure.

FIG. 5 illustrates the data delay according to one embodiment of the present disclosure.

FIG. 6 illustrates the transmission for sending the data packet numbered “17” to “20” according to one embodiment of the present disclosure.

FIG. 7 shows the operation of the jitter buffer while data delay according to one embodiment of the present disclosure.

FIG. 8 shows an extended SR period to reduce the SR transmission number according to one embodiment of the present disclosure.

FIG. 9 illustrates the transmission for sending the data packets numbered “16” to “19” in case of the extended SR period according to one embodiment of the present disclosure.

FIG. 10 shows the operation of the jitter buffer in case of the extended SR period according to one embodiment of the present disclosure.

FIG. 11 shows the operation of the jitter buffer while data delay in case of the extended SR period according to one embodiment of the present disclosure.

FIG. 12 shows the silence mode according to one embodiment of the present disclosure.

FIG. 13 shows a block diagram of the user equipment according to one embodiment of the present disclosure.

FIG. 14 shows a flowchart of the controlling method for the user equipment according to one embodiment of the present disclosure.

FIG. 15 shows a flowchart of the controlling method for the user equipment to select some of the SR occasions according to one embodiment of the present disclosure.

FIG. 16 shows a flowchart of the controlling method for the user equipment to select some of the SR occasions according to one embodiment of the present disclosure.

FIG. 17 shows a flowchart of the controlling method for the user equipment to select some of the SR occasions according to one embodiment of the present disclosure.

FIG. 18 shows a flowchart of the controlling method for the user equipment to select some of the SR occasions according to one embodiment of the present disclosure.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

### DETAILED DESCRIPTION

The technical terms used in this specification refer to the idioms in this technical field. If there are explanations or definitions for some terms in this specification, the explanation or definition of this part of the terms shall prevail. Each embodiment of the present disclosure has one or more technical features. To the extent possible, a person with ordinary skill in the art may selectively implement some or all of the technical features in any embodiment, or selectively combine some or all of the technical features in these embodiments.

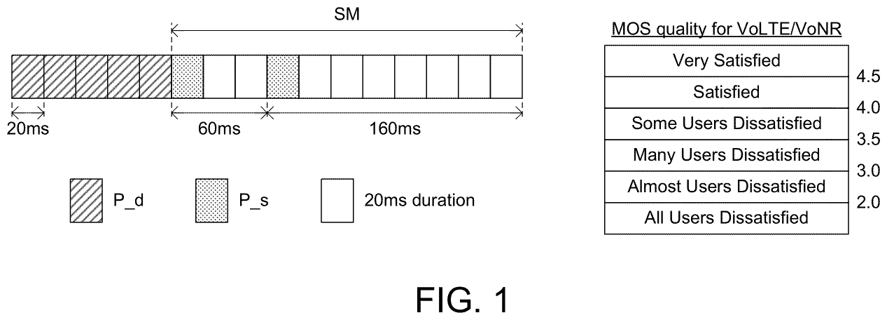

Please refer to FIG. 1, which illustrates the data pattern according to one embodiment of the present disclosure. In VoLTE and/or VoNR (not limited) data transmission for every predetermined length, such as 20 ms, is encoded into one data packet P_d. The present disclosure is illustrated via VoLTE and/or VoNR, but it is not used to limit the present disclosure. The data packet P_d is, for example, voice packet or video packet or IP packet. In this embodiment, the data packet P_d is voice packet. When there is no voice, a silence packet (SID) P_s is transmitted and then it will switch to a silence mode SM for 60 ms or 160 ms.

The mean opinion score (MOS) for VoLTE, VoNR is used to indicate the quality of transmission. Generally speaking, if the mean opinion score is equal to or higher than 4, the quality of the transmission is accepted.

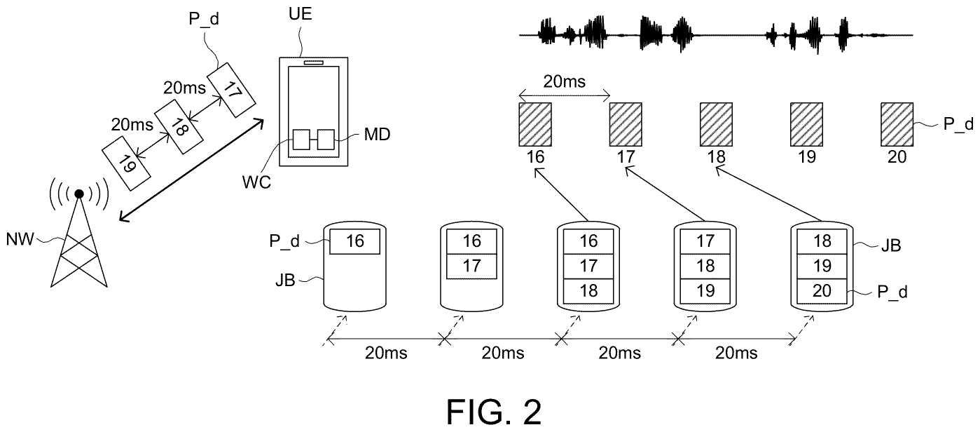

Please refer to FIG. 2, which shows the transmission between the network NW and the user equipment UE in the examples of VoLTE and/or VoNR according to one embodiment of the present disclosure. The user equipment UE includes a wireless communication module WC and a modem chip MD. The modem chip MD is connected to the wireless communication module WC. The wireless communication module WC is used to communicate with the network NW. Every 20 ms, one of the data packets P_d may be transmitted. A jitter buffer JB is used to temporarily store the data packets P_d. As shown in the FIG. 2, when the data packet P_d numbered “18” is stored in the jitter buffer JB, the data packet P_d numbered “16” is outputted.

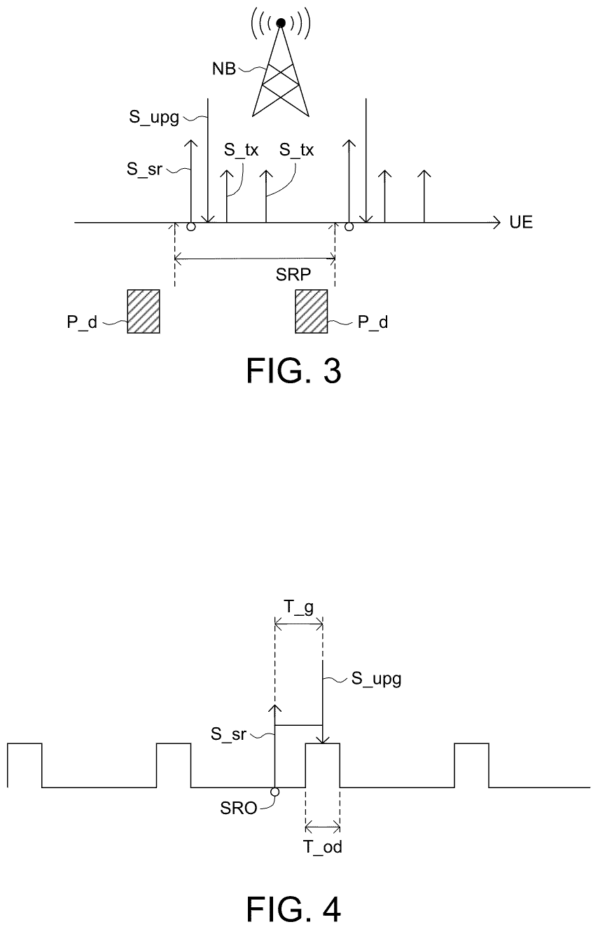

Please refer to FIG. 3, which illustrates the data transmission for the data packet P_d according to one embodiment of the present disclosure. During a scheduling request period SRP, the user equipment UE would transmits a scheduling request signal S_sr to the network NW, and then the network may return an uplink grant signal S_upg. After receiving the uplink grant signal S_upg, the user equipment UE would transmit transmission signal(s) S_tx to the network NW for sending the data packet P_d. In the embodiment shown in the FIG. 3, one data packet P_d is transmitted after transmitting the scheduling request signal S_sr.

Please refer to FIG. 4, which illustrates the discontinuous reception (DRX) active time overlap for the user equipment UE according to one embodiment of the present disclosure. For receiving the uplink grant signal S_upg, the user equipment UE must monitor the channel in a time period T_g from transmitting the scheduling request signal S_sr until receiving the uplink grant signal S_upg. If the user equipment UE receives the DRX configuration from the network NW, the user equipment UE must monitor the channel in a time period T_od due to On-duration. For power saving, the time period T_g is set to be overlapped with the time period T_od. The more overlap, the more power is saved. In FIG. 4, the time period T_g from transmitting the scheduling request signal S_sr until receiving the uplink grant signal S_upg is not used to limit the present disclosure.

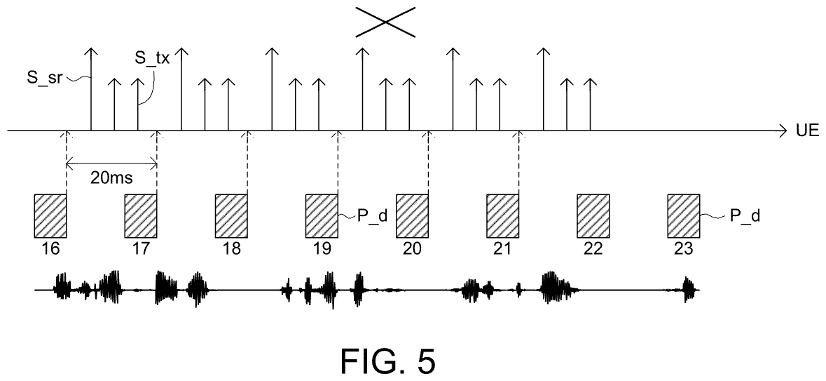

Please refer to FIG. 5, which illustrates the data delay according to one embodiment of the present disclosure. In case of poor transmission environment, scheduling request signal S_sr used for sending the data packet P_d numbered “19” may be failed to transmit, therefore UE cannot perform the transmission signal S_tx for the data packet P_d numbered “19”. Then, the next transmission signal S_tx would be used for sending two data packets P_d numbered “19” and “20”.

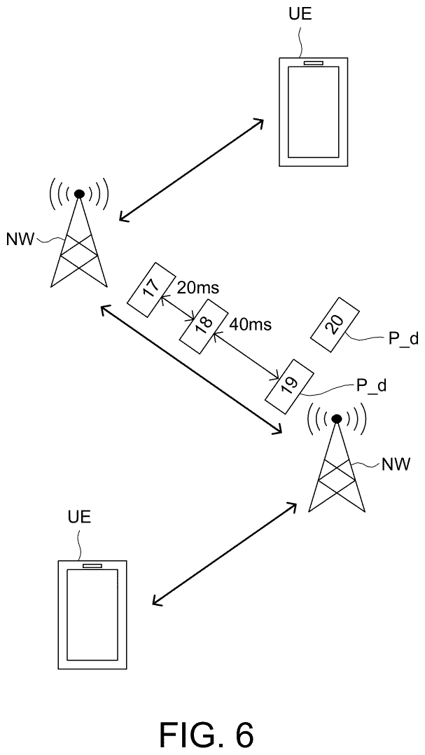

Please refer to FIG. 6, which illustrates the transmission for sending the data packets P_d numbered “17” to “20” according to one embodiment of the present disclosure. The data packets P_d are transmitted for every 20 ms. But, the data packet P_d numbered “19” is delayed, so the data packets P_d numbered “19” and “20” would be transmitted together.

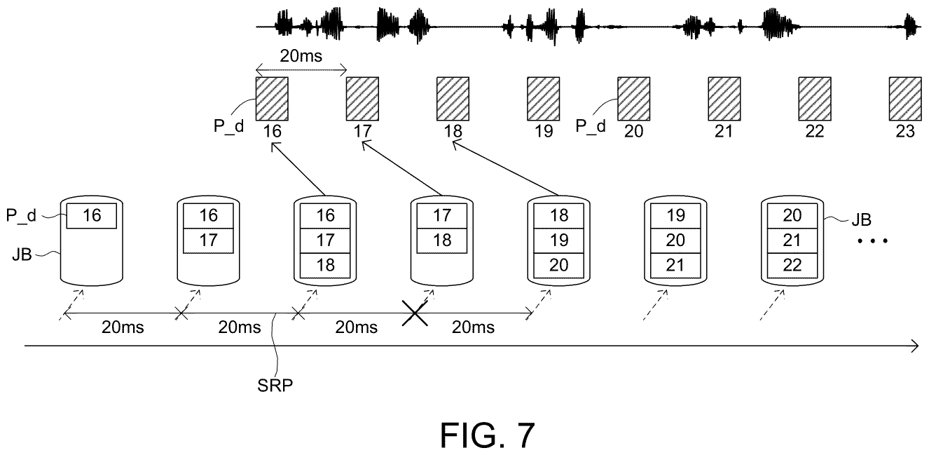

Please refer to FIG. 7, which shows the operation of the jitter buffer JB while data delay according to one embodiment of the present disclosure. Even if the data packet P_d numbered “19” is delayed, the data packets P_d numbered “17” and “18” are stored and the data packets P_d numbered “17” can be outputted without breaking voice. Next, the data packets P_d numbered “19” and “20” could be stored in the jitter buffer JB before outputting. The sound could be continuously played without breaking, even if some of the data packets are delayed. Therefore, the mean opinion score (MOS) for the transmission could be kept well.

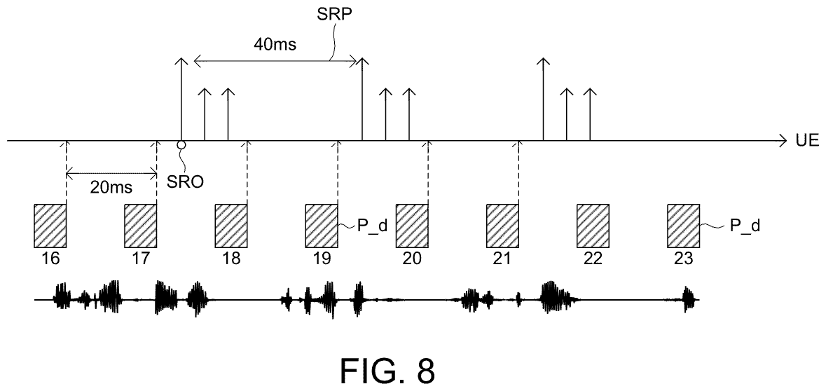

Please refer to FIG. 8, which shows an extended SR period SRP to reduce the SR transmission number according to one embodiment of the present disclosure. Because the mean opinion score (MOS) could be kept well by using the jitter buffer JB. The accept delay of Voice service is 40 ms in this embodiment. UE could select a plurality of SR occasions according to accept delay to reduce SR transmission number, the selection way is via extended the SR period SRP in this embodiment. For example, as shown in the FIG. 8, the SR period SRP is extended from 20 ms to 40 ms. After transmitting one SR signal S_sr, the transmission signal(s) S_tx could be used to sending two data packets P_d.

In one embodiment, UE could select a plurality of SR occasions via controlling data coming pattern, such as configure the frequency of data transmitted from application to modem, application such as VoLTE, such as increase or decrease the frequency. For instance, if NW allows UE perform SR at air time 5, 25, 45, 65 . . . by SR configuration, UE selects air time 5 and 45 to perform SR transmit by controlling the data coming to MD time at air time 3, 43. In this case, UE will transmit the SR at air time 5 and 45.

In one embodiment, UE could select a plurality of SR occasions via SR suppression. For instance, if NW allow UE perform SR at air time 5, 25, 45, 65 . . . by SR configuration, UE selects air time 5 and 45 to perform SR transmit by prohibit SR trigger or prohibit SR transmission at air time 25, 65. In this embodiment UE will transmit the SR at air time 5 and 45 if data coming to MD at air time 3, 23, 43.

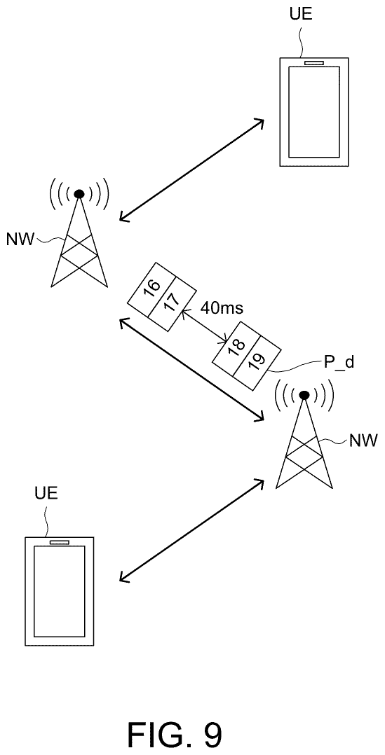

Please refer to FIG. 9, which illustrates the transmission for sending the data packets P_d numbered “16” to “19” in case of the extended SR period SRP according to one embodiment of the present disclosure. Two data packets P_d are transmitted for every 40 ms.

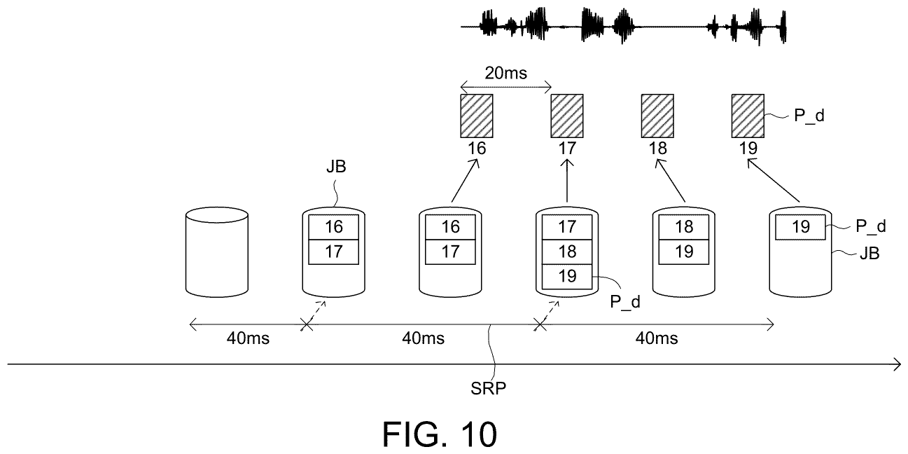

Please refer to FIG. 10, which shows the operation of the jitter buffer JB in case of the extended SR period SRP according to one embodiment of the present disclosure. The data packets P_d numbered “16” and “17” are stored in the jitter buffer JB at the same time, and then the data packets P_d numbered “16” and “17” are outputted at different times in sequence. When the data packet P_d number “17” is outputted, the data packets P_d numbered “18” and “19” are stored. The data packets P_d numbered “18” and “19” are stored in the jitter buffer JB before outputting. The sound or could be continuously played without breaking, even if the SR period SRP is extended. Therefore, the mean opinion score (MOS) for the transmission could be kept well.

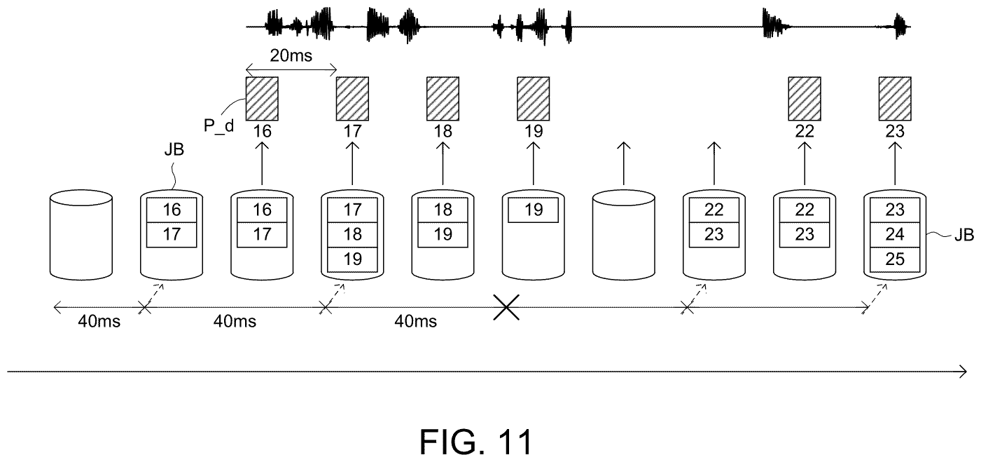

Please refer to FIG. 11, which shows the operation of the jitter buffer JB while data delay in case of the extended SR period SRP according to one embodiment of the present disclosure. If the transmission environment is poor, the transmission signal(s) S_tx may be delayed and the data packets P_d numbered “20” and “21” may not be stored in the jitter buffer JB. This would result sound/video breaking. Therefore, even if some of the data packets are delayed. Therefore, the SR transmit number should be dynamically adjusted according to the transmission environment.

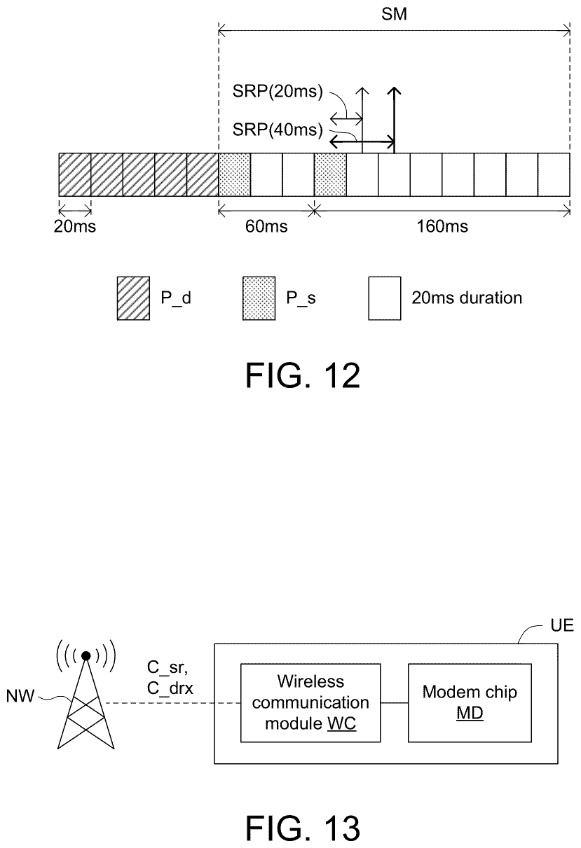

Please refer to FIG. 12, which shows the silence mode SM according to one embodiment of the present disclosure. When there is no voice, the silence packet (SID) P_s is transmitted and then it will switch to the silence mode SM for 60 ms, 160 ms or more. Because, two data packets will not arrive within one SR period SRP during the silence mode SM, so the SR period SRP could be reduced from 40 ms to 20 ms to reduce the latency without increasing power consumption.

According to the description as above, the reduced SR transmission number could reduce the power consumption. The user equipment UE could perform a controlling method as below to dynamically adjust the SR transmission number.

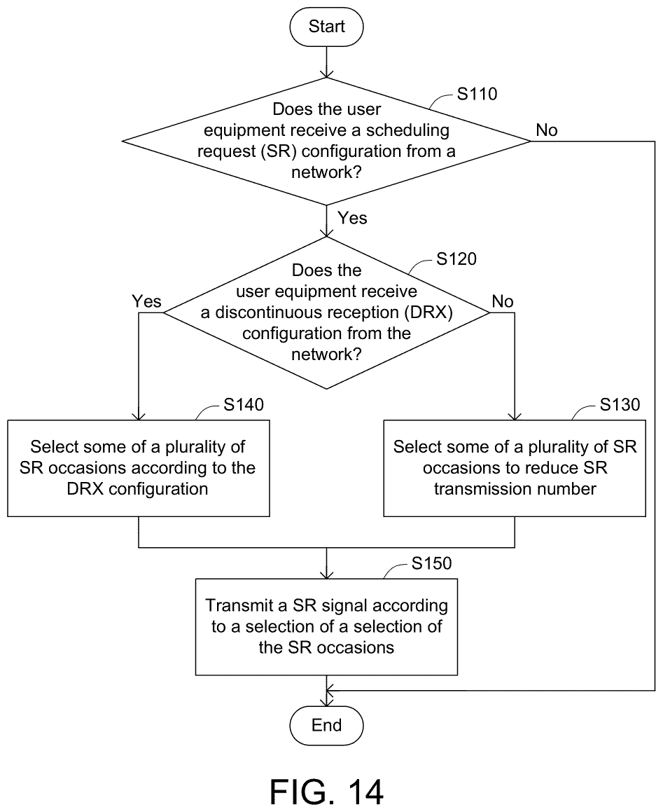

Please refer to FIGS. 13 and 14. FIG. 13 shows a block diagram of the user equipment UE according to one embodiment of the present disclosure. FIG. 14 shows a flowchart of the controlling method for the user equipment UE according to one embodiment of the present disclosure. The controlling method for the user equipment UE includes, for example, steps S110 to S150. In the step S110, as shown in the FIG. 14, the modem chip MD of the user equipment UE determines whether the user equipment UE receives a SR configuration C_sr from the network NW. If the user equipment UE receives the SR configuration C_sr from the network NW, then the process proceeds to the step S120.

In the step S120, as shown in the FIG. 13, the modem chip MD of the user equipment UE determines whether the user equipment UE receives a discontinuous reception (DRX) configuration C_drx from the network NW. If the user equipment UE does not receive the DRX configuration C_drx, then the process proceeds to the step S130; if the user equipment UE receives the DRX configuration C_drx, then the process proceeds to the step S140.

In the S130, as shown in the FIG. 14, the modem chip MD selects some of a plurality of SR occasions SRO to reduce SR transmission number. For example, the modem chip MD may selects the SR occasion SRO to be closest to the data and greater than the data coming time. The SR occasion SRO is selected from one of a plurality of SR transmission candidates in which is most closed to data to be transmitted. The SR occasion SRO is selected according to the accept delay of on-going service.

In this step, the accept delay is determined according to on-going service, in above instance, VoLTE and/or VoNR, is 40 ms.

In the step S140, as showing in the FIG. 14, the modem chip MD selects some of the SR occasions according to the DRX configuration C_drx (shown in the FIG. 14). For example, the SR occasion SRO is selected from one of a plurality of SR transmission candidates to minimize the DRX active time in one or a plurality DRX cycle, the way may be select the SR occasion SRO which is most closed to On-Duration timer start time.

Next, in the step S150, as shown in the FIG. 14, the modem chip MD controls the wireless communication module WC to transmit the SR signal S_sr according to a selection of the SR occasions SRO.

In this step, modem chip MD may perform this step through the following manners: (1) adjusting the SR period SRP; (2) controlling data coming pattern to delay the transmission for the SR signal S_sr; (3) SR suppression by prohibiting the transmission or triggering for the SR signal S_sr.

Further, for keeping the communication quality, the SR transmission number may be dynamically adjusted through the following methods.

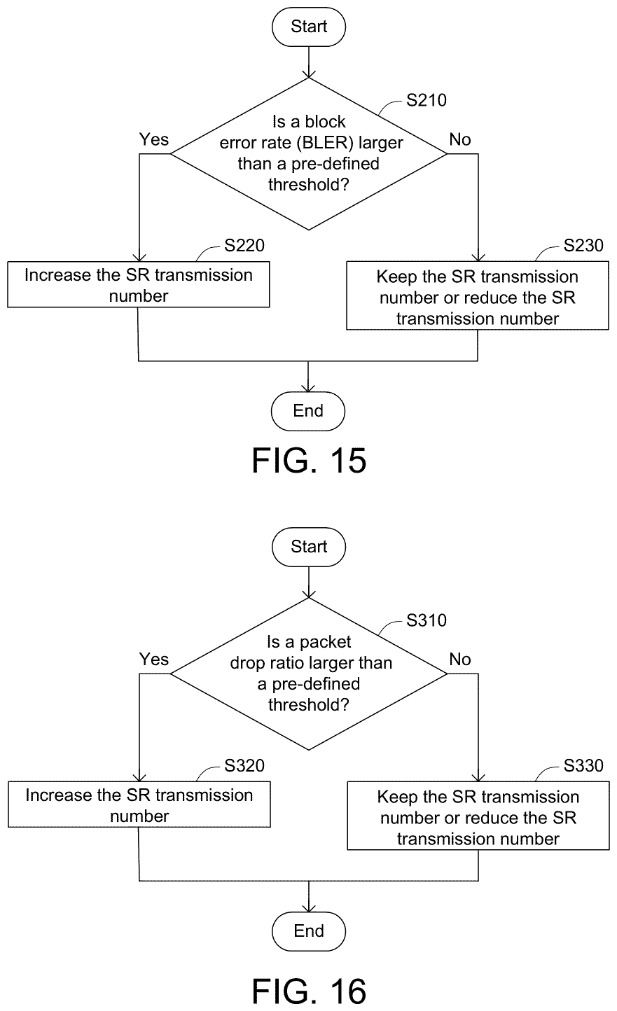

Please refer to FIG. 15, which shows a flowchart of the controlling method for the user equipment UE to select some of the SR occasions SRO according to one embodiment of the present disclosure. The controlling method in the FIG. 15 includes step S210 to S230. In the S210, the modem chip MD determines whether a block error rate (BLER) is larger than a pre-defined threshold. If the BLER is larger than the pre-defined threshold, the process proceeds to the step S220; if the BLER is not larger than the pre-defined threshold, the process proceeds to the step S230.

In the S220, the modem chip MD of the user equipment UE increases the SR transmission number by select the SR occasion SRO which is closed to data coming time and after the data coming time to prevent the data delay shown in the FIG. 11.

In the S230, the modem chip MD of the user equipment UE keeps the SR transmission number or reduces the SR transmission number for power saving.

In some case, if data arrival period greater than SR period, the SR transmission number may not change, but delay still reduces due to selected the SR occasion SRO which is closest to the data and greater than the data coming time.

Please refer to FIG. 16, which shows a flowchart of the controlling method for the user equipment UE to select some of the SR occasions SRO according to one embodiment of the present disclosure. The controlling method in the FIG. 16 includes step S310 to S330. In the step S310, the modem chip MD of the user equipment UE determines whether a packet drop ratio is larger than a pre-defined threshold. If the packet drop ratio is larger than the pre-defined threshold, the process proceeds to the step S320; if the packet drop ratio is not larger than the pre-defined threshold, the process proceeds to the step S330.

In the S320, the modem chip MD of the user equipment UE increases the SR transmission number to prevent the data delay shown in the FIG. 11.

In the S330, the modem chip MD of the user equipment UE keeps the SR transmission number or reduces the SR transmission number for power saving.

In some case, if data arrival period greater than SR period, the SR transmission number may not change, but delay still reduces due to selected the SR occasion SRO which is closest to the data and greater than the data coming time.

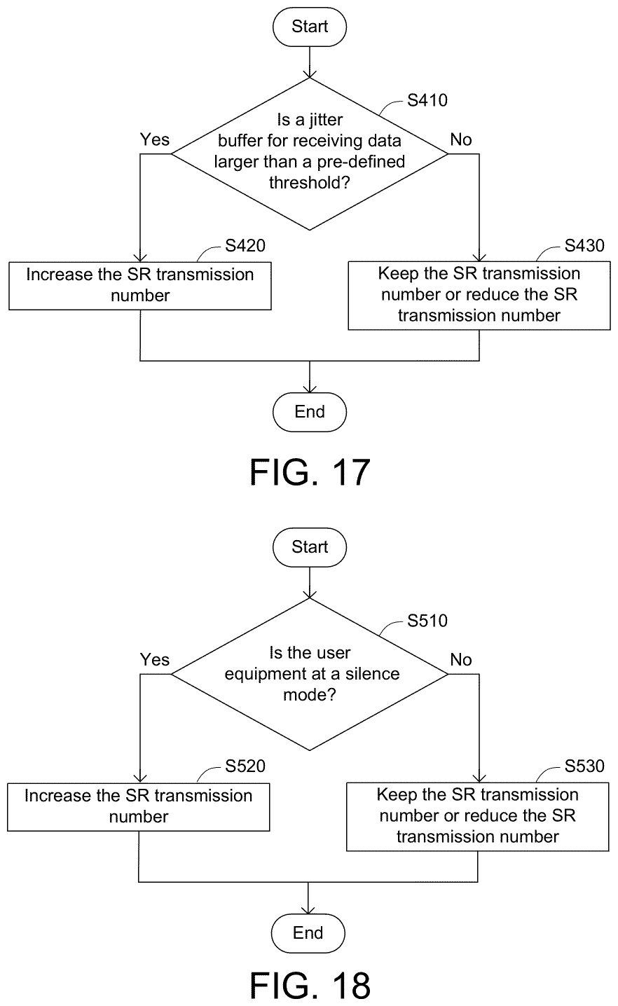

Please refer to FIG. 17, which shows a flowchart of the controlling method for the user equipment UE to select some of the SR occasions SRO according to one embodiment of the present disclosure. The controlling method in the FIG. 17 includes step S410 to S430. In the step S410, the modem chip MD of the user equipment UE determines whether a jitter at receive side is larger than a pre-defined threshold. If the jitter at receive side is larger than the pre-defined threshold, the process proceeds to the step S420; if the jitter at receive side is not larger than the pre-defined threshold, the process proceeds to the step S430.

In the S420, the modem chip MD of the user equipment UE increase the SR transmission number to prevent the data delay.

In the S430, the modem chip MD of the user equipment UE keeps the SR transmission number or reduce the SR transmission number for power saving shown in the FIG. 11.

In some case, if data arrival period greater than SR period, the SR transmission number may not change, but delay still reduces due to selected the SR occasion SRO which is closest to the data and greater than the data coming time.

Please refer to FIG. 18, which shows a flowchart of the controlling method for the user equipment UE to select some of the SR occasions SRO according to one embodiment of the present disclosure. The controlling method in the FIG. 18 includes step S510 to S530. In the step S510 the modem chip MD of the user equipment UE determines whether the user equipment UE is at the silence mode SM. If the user equipment UE is at the silence mode SM, the process proceeds to the step S520; if the user equipment UE is not at the silence mode SM, the process proceeds to the step S530.

In the S520, the modem chip MD of the user equipment UE increases the SR transmission number to reduce the latency.

In the step S530, the modem chip MD of the user equipment UE keeps the SR transmission number or reduce the SR transmission number for power saving as shown in the FIG. 12.

In some case, if data arrival period greater than SR period, the SR transmission number may not change, but delay still reduces due to selected the SR occasion SRO which is closest to the data and greater than the data coming time.

According to the description as above, the reduced SR transmission number could reduce the power consumption. Further, the SR transmission number could be dynamically adjusted to prevent the data delay and reduce the latency in the silence mode SM.

The above disclosure provides various features for implementing some implementations or examples of the present disclosure. Specific examples of components and configurations (such as numerical values or names mentioned) are described above to simplify/illustrate some implementations of the present disclosure. Additionally, some embodiments of the present disclosure may repeat reference symbols and/or letters in various instances. This repetition is for simplicity and clarity and does not inherently indicate a relationship between the various embodiments and/or configurations discussed.

It will be apparent to those skilled in the art that various modifications and variations can be made to the disclosed embodiments. It is intended that the specification and examples be considered as exemplars only, with a true scope of the disclosure being indicated by the following claims and their equivalents.

What is claimed is:

1. A controlling method for a user equipment which is a communication device, comprising:
determining whether the user equipment receives a scheduling request (SR) configuration from a network;
reducing SR transmission number by selecting a plurality of SR occasions; and
transmitting a SR signal according to selected SR occasions.

2. The controlling method for the user equipment according to claim 1, wherein selecting the plurality of SR occasions is via extending SR period, controlling data arrival pattern or SR suppression.

3. The controlling method for the user equipment according to claim 1, wherein selected SR occasions are decided according to an accept delay, and the accept delay is determined according to current on-going services including VoLTE and/or VoNR and/or streaming, or a pre-defined value.

4. The controlling method for the user equipment according to claim 1, wherein in selection of the SR occasions, one of a plurality of SR transmission candidates which is most closed to a data coming time and greater than the data coming time is selected.

5. The controlling method for the user equipment according to claim 1, further comprising:
selecting some of the SR occasions or controlling data pattern according to the DRX configuration, if the user equipment receives the DRX configuration from the network.

6. The controlling method for the user equipment according to claim 5, wherein if the user equipment receives the DRX configuration from the network, the SR occasion is selected from one of a plurality of SR transmission candidates which is most closed to On-Duration timer start time or the user equipment is controlled to have minimize DRX active time within one or a plurality of DRX cycles.

7. The controlling method for the user equipment according to claim 1, further comprising:
determining whether a block error rate (BLER) is larger than a pre-defined threshold; and
increasing the SR transmission number, if the BLER is larger than the pre-defined threshold.

8. The controlling method for the user equipment according to claim 1, further comprising:
determining whether a packet drop ratio is larger than a pre-defined threshold; and
increasing the SR transmission number, if the packet drop ratio is larger than the pre-defined threshold.

9. The controlling method for the user equipment according to claim 1, further comprising:
determining whether a jitter at receive side for receiving data is larger than a pre-defined threshold; and
increasing the SR transmission number, if the jitter for receiving data at receive side is larger than the pre-defined threshold.

10. The controlling method for the user equipment according to claim 1, further comprising:
determining whether the user equipment is at a silence mode; and
increasing the SR transmission number, if the user equipment is at the silence mode.

11. A modem chip equipped in a user equipment which is a communication device, wherein the modem chip is used to
determine whether the user equipment receives a scheduling request (SR) configuration from a network;
reduce SR transmission number by selecting a plurality of SR occasions; and
control the wireless communication module to transmit a SR signal according to selected SR occasions.

12. The modem chip equipped in the user equipment according to claim 11, wherein selecting the plurality of SR occasions is via extending SR period, controlling data arrival pattern or SR suppression.

13. The modem chip equipped in the user equipment according to claim 11, wherein selected SR occasions are decided according to an accept delay, and the accept delay is determined according to current on-going service including VoLTE, VONR.

14. The modem chip equipped in the user equipment according to claim 11, wherein in the selection of the SR occasions, one of a plurality of SR transmission candidates which is most closed to data coming time is selected, if the user equipment does not receive the DRX configuration from the network.

15. The modem chip equipped in the user equipment according to claim 11, wherein the modem chip is further used to:
select some of the SR occasions or control data pattern according to the DRX configuration, if the user equipment receives the DRX configuration from the network.

16. The modem chip equipped in the user equipment according to claim 11, wherein if the user equipment receives the DRX configuration from the network, the SR occasion is selected from one of a plurality of SR transmission candidates which is most closed to On-Duration timer start time or the user equipment is controlled to have minimize DRX active time within a DRX cycle.

17. The modem chip equipped in the user equipment according to claim 11, wherein the modem chip is further used to:
determine whether a block error rate (BLER) is larger than a pre-defined threshold; and
increase the SR transmission number, if the BLER is larger than the pre-defined threshold.

18. The modem chip equipped in the user equipment according to claim 11, wherein the modem chip is further used to:
determine whether a packet drop ratio is larger than a pre-defined threshold; and
increase the SR transmission number, if the packet drop ratio is larger than the pre-defined threshold.

19. The modem chip equipped in the user equipment according to claim 11, wherein the modem chip is further used to:
determine whether a jitter buffer for receiving data is larger than a pre-defined threshold; and
increase the SR transmission number, if the jitter buffer for receiving data is larger than the pre-defined threshold.

20. A user equipment, which is a communication device, wherein the user equipment comprises:
a wireless communication module;
a modem chip, connected to the wireless communication module, wherein the modem chip is used to
determine whether the user equipment receives a scheduling request (SR) configuration from a network;
reduce SR transmission number by selecting a plurality of SR occasions; and
control the wireless communication module to transmit a SR signal according to selected SR occasions.
